(19) United States
(12) Patent Application Publication
(10) Pub. No.: US 2021/0173245 A1
(43) Pub. Date: Jun. 10, 2021

(54) DISPLAY APPARATUS

(71) Applicant: Japan Display Inc., Tokyo (JP)

(72) Inventors: Hayato Kurasawa, Tokyo (JP); Hiroshi Mizuhashi, Tokyo (JP); Fumitaka Gotoh, Tokyo (JP); Gen Koide, Tokyo (JP); Tadayoshi Katsuta, Tokyo (JP)

(21) Appl. No.: 17/181,038

(22) Filed: Feb. 22, 2021

Related U.S. Application Data
(63) Continuation of application No. PCT/JP2019/028668, filed on Jul. 22, 2019.

(30) Foreign Application Priority Data
Aug. 24, 2018 (JP) 2018-157526

(51) Int. Cl. G02F 1/1368; G02F 1/1362; G02F 1/1333; G06F 3/046

(52) U.S. Cl. CPC G02F 1/1368; G06F 3/046; G02F 1/13338; G02F 1/136286

(57) ABSTRACT

According to an aspect, a display apparatus includes: a substrate; a plurality of pixel electrodes provided in a display area; a plurality of switching elements coupled to the respective pixel electrodes; a plurality of first electrodes provided between semiconductors of the switching elements and the substrate in a direction orthogonal to the substrate and extending in a first direction; a plurality of signal lines coupled to the switching elements and extending in a second direction intersecting the first direction; a coupling member provided in a peripheral area outside the display area and configured to couple ends of the first electrodes to each other; and a drive circuit configured to output a first drive signal to the first electrodes or the signal lines during a first sensing period in which an electromagnetic induction method is used.

### CROSS-REFERENCE TO RELATED APPLICATIONS

This application claims the benefit of priority from Japanese Patent Application No. 2018-157526 filed on Aug. 24, 2018 and International Patent Application No. PCT/JP2019/028668 filed on Jul. 22, 2019, the entire contents of which are incorporated herein by reference.

### BACKGROUND

### 1. Technical Field

The present disclosure relates to a display apparatus.

### 2. Description of the Related Art

In recent years, touch detection apparatuses commonly called touchscreen panels capable of detecting an external proximate object have been attracting attention. Such a touchscreen panel is mounted on or integrated with a display apparatus such as a liquid crystal display apparatus, which is used as a display apparatus with a touch detection apparatus. A capacitance method and an electromagnetic induction method are known as methods for detecting such an external proximate object. In the electromagnetic induction method, coils for generating magnetic fields and coils for detecting the magnetic fields are provided in the display apparatus. A pen serving as the external object is provided with a coil and a capacitive element forming a resonant circuit. The display apparatus detects the pen using electromagnetic induction between each of the coils in the display apparatus and the coil in the pen. Japanese Patent Application Laid-open Publication No. H10-49301 describes a coordinate input device using the electromagnetic induction method.

The capacitance method greatly differs from the electromagnetic induction method in the configuration of a detection target and detection electrodes. Therefore, if the electrodes and various types of wiring provided in the display apparatus and the drive configuration thereof are employed without modification in the electromagnetic induction method, the electromagnetic induction touch detection may be difficult to be satisfactorily performed.

### SUMMARY

According to an aspect, a display apparatus includes: a substrate; a plurality of pixel electrodes provided in a display area; a plurality of switching elements coupled to the respective pixel electrodes; a plurality of first electrodes provided between semiconductors of the switching elements and the substrate in a direction orthogonal to the substrate and extending in a first direction; a plurality of signal lines coupled to the switching elements and extending in a second direction intersecting the first direction; a coupling member provided in a peripheral area outside the display area and configured to couple ends of the first electrodes to each other; and a drive circuit configured to output a first drive signal to the first electrodes or the signal lines during a first sensing period in which an electromagnetic induction method is used.

### BRIEF DESCRIPTION OF THE DRAWINGS

FIG. 1 is a block diagram illustrating a configuration of a display apparatus according to a first embodiment of the present disclosure;

FIG. 2 is an explanatory diagram for explaining electromagnetic induction touch detection;

FIG. 3 is a sectional view illustrating a schematic structure of the display apparatus according to the first embodiment;

FIG. 4 is a plan view schematically illustrating the display apparatus according to the first embodiment;

FIG. 5 is a circuit diagram illustrating a pixel array of the display apparatus according to the first embodiment;

FIG. 6 is a VI-VI′ sectional view of FIG. 4;

FIG. 7 is a plan view illustrating an enlarged view of first electrodes according to the first embodiment;

FIG. 8 is a circuit diagram illustrating a coupling configuration of the first electrodes according to the first embodiment;

FIG. 9 is a block diagram illustrating a drive circuit that supplies various signals;

FIG. 10 is a circuit diagram illustrating a coupling configuration of signal lines according to the first embodiment;

FIG. 11 is a circuit diagram illustrating a coupling configuration of the first electrodes and the signal lines according to a second embodiment of the present disclosure;

FIG. 12 is a plan view illustrating an enlarged view of a coupling portion between the first electrodes and detection signal output lines according to the second embodiment;

FIG. 13 is a XIII-XIII′ sectional view of FIG. 12;

FIG. 14 is a circuit diagram illustrating a coupling configuration of gate lines and the signal lines according to a third embodiment of the present disclosure;

FIG. 15 is a timing waveform diagram illustrating an operation example of the display apparatus according to the third embodiment;

FIG. 16 is a circuit diagram illustrating a coupling configuration of the gate lines and the signal lines according to a fourth embodiment of the present disclosure;

FIG. 17 is a plan view schematically illustrating a display apparatus according to a fifth embodiment of the present disclosure; and

FIG. 18 is a sectional view illustrating a schematic structure of a display apparatus according to a sixth embodiment of the present disclosure.

### DETAILED DESCRIPTION

The following describes embodiments for carrying out the present disclosure in detail with reference to the drawings. The present disclosure is not limited to the description of the embodiments given below. Components described below include those easily conceivable by those skilled in the art or those substantially identical thereto. Moreover, the components described below can be appropriately combined. The disclosure is merely an example, and the present disclosure naturally encompasses appropriate modifications easily conceivable by those skilled in the art while maintaining the gist of the disclosure. To further clarify the description, widths, thicknesses, shapes, and other properties of various parts are schematically illustrated in the drawings as compared with actual aspects thereof, in some cases. However, they are merely examples, and interpretation of the present disclosure is not limited thereto. The same element as that illustrated in a drawing that has already been discussed is denoted by the same reference numeral through the description and the drawings, and detailed description thereof will not be repeated in some cases where appropriate.

In this disclosure, when an element is described as being “on” another element, the element can be directly on the other element, or there can be one or more elements between the element and the other element.

### First Embodiment

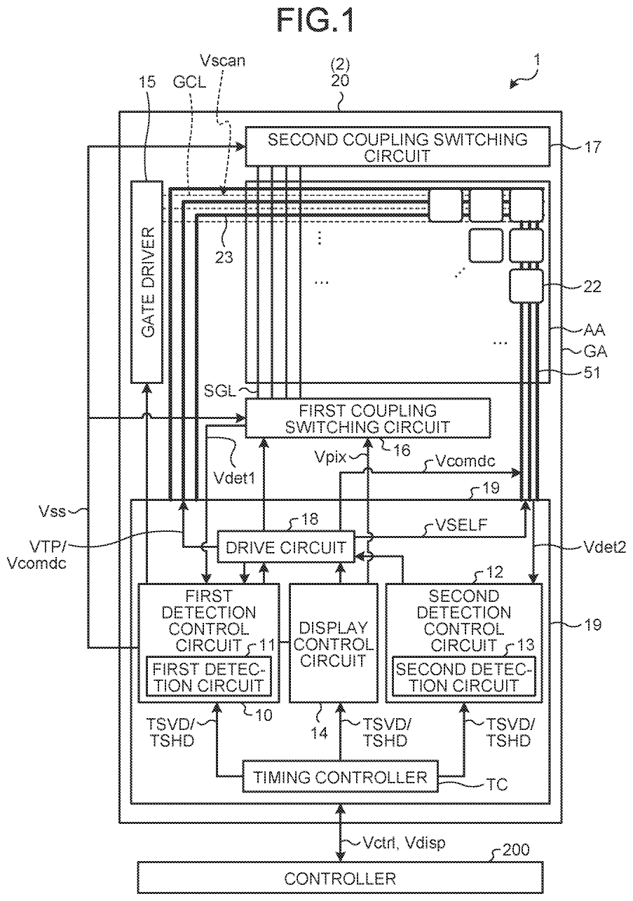

FIG. 1 is a block diagram illustrating a configuration of a display apparatus according to a first embodiment of the present disclosure. A display apparatus 1 of the present embodiment incorporates a detection function to detect contact with and/or proximity to a display surface by a detection target body. As illustrated in FIG. 1, the display apparatus 1 includes a display panel 20, a first detection control circuit 10, a second detection control circuit 12, a display control circuit 14, a gate driver 15, a first coupling switching circuit 16, a second coupling switching circuit 17, a drive circuit 18, and a controller 200.

The display panel 20 is, for example, a liquid crystal display apparatus that uses liquid crystals as display elements. The display panel 20 is a device that performs display in response to a scan signal Vscan supplied from the gate driver 15. More specifically, the display panel 20 is a device that sequentially scans each horizontal line in response to the scan signal Vscan to perform the display.

The controller 200 is a circuit that supplies a control signal Vctrl to the first detection control circuit 10, the second detection control circuit 12, and the display control circuit 14 to control the display and the detection of the display panel 20. The first detection control circuit 10, the second detection control circuit 12, and the display control circuit 14 are provided as a drive integrated circuit (IC) 19 on the display panel 20. The drive IC 19 may, however, be provided to a wiring substrate 71 or a control circuit substrate coupled to the display panel 20. At least one of the first detection control circuit 10, the second detection control circuit 12, the drive circuit 18, and the display control circuit 14 may be provided to the display panel 20 without being incorporated in the drive IC 19. The wiring substrate 71 is, for example, a flexible printed circuit board.

The display control circuit 14 supplies control signals to the gate driver 15 and the first coupling switching circuit 16 based on a video signal Vdisp supplied from the controller 200.

The gate driver 15 is a circuit that sequentially selects one horizontal line as a target of display driving of the display panel 20 based on a control signal supplied from the display control circuit 14.

The first coupling switching circuit 16 and the second coupling switching circuit 17 are switching circuits that change a coupling state of signal lines SGL based on a switching signal Vss from the first detection control circuit 10. The first coupling switching circuit 16 supplies a pixel signal Vpix to each pixel Pix of the display panel 20 based on the control signal supplied from the display control circuit 14 during a display period. The display control circuit 14 supplies a display drive signal Vcomdc through the drive circuit 18 to detection electrodes 22 during the display period.

The display panel 20 has a function to perform self-capacitive touch detection to detect a position of a finger in contact with or in proximity to the display surface of the display panel 20. The display panel 20 also has a function to perform electromagnetic induction touch detection to detect a touch pen 100 in contact with or in proximity to the display surface. A timing controller TC supplies control signals TSVD and TSHD for controlling timing of the electromagnetic induction touch detection by the first detection control circuit 10, the self-capacitive touch detection by the second detection control circuit 12, and the display by the display control circuit 14.

The first detection control circuit 10 is a circuit that controls the electromagnetic induction touch detection based on the control signals TSVD and TSHD supplied from the timing controller TC included in the drive IC 19. The first detection control circuit 10 supplies a first drive signal VTP through the drive circuit 18 to transmitting coils CTx formed by electrodes or wiring of the display panel 20 during an electromagnetic induction detection period (hereinafter, called “first sensing period”). When any one of receiving coils CRx of the display panel 20 has detected the contact or the proximity of the touch pen 100 using an electromagnetic induction method, the receiving coil CRx outputs a first detection signal Vdet1 to the first detection control circuit 10. In the present embodiment, the transmitting coils CTx are first electrodes 67, and the receiving coils CRx are the signal lines SGL.

The second detection control circuit 12 is a circuit that controls the capacitive touch detection based on the control signals supplied from the controller 200 and the timing controller TC. The second detection control circuit 12 supplies a second drive signal VSELF through the drive circuit 18 to the detection electrodes 22 of the display panel 20 during a capacitive detection period (hereinafter, called “second sensing period”). When the display panel 20 has detected the contact or the proximity of the finger using the capacitance method, the display panel 20 outputs a second detection signal Vdet2 to the second detection control circuit 12. The first drive signal VTP and the second drive signal VSELF are each, for example, an alternating-current rectangular wave having a predetermined frequency (ranging, for example, roughly from several kilohertz to several hundred kilohertz). The alternating-current waveform of each of the first drive signal VTP and the second drive signal VSELF may be a sinusoidal waveform or a triangular waveform.

The first detection control circuit 10 includes a first detection circuit 11 that receives the first detection signals Vdet1 from the receiving coils CRx. The first detection circuit 11 transmits the received first detection signals Vdet1 as output signals to outside the display panel 20 (to, for example, the controller 200). The second detection control circuit 12 includes a second detection circuit 13 that receives the second detection signals Vdet2 from the detection electrodes 22. The second detection circuit 13 transmits the received second detection signals Vdet2 as output signals to outside the display panel 20 (to, for example, the controller 200). The first detection circuit 11 and the second detection circuit 13, that is, the first detection circuit 11 and the second detection circuit 13 serving as, for example, analog front-end (hereinafter, referred to as AFE) circuits include signal processing circuits for performing signal adjustment, such as filter circuits for reducing noise and amplifying circuits for amplifying signal components of the first detection signal Vdet1 and the second detection signal Vdet2 supplied to the detection circuits 11 and 13, respectively. The first detection circuit 11 and the second detection circuit 13 may include no signal processing circuits, and may supply the first detection signal Vdet1 and the second detection signal Vdet2 as they are as output signals to the controller 200, and the controller 200 may include the signal processing circuits such as the filter circuits and the amplifying circuits.

The first detection control circuit 10 and the second detection control circuit 12 may include, for example, analog-to-digital (A/D) conversion circuits, signal processing circuits, and coordinate extraction circuits for performing signal processing of the first detection signal Vdet1 and the second detection signal Vdet2, respectively. Alternatively, the controller 200 may include, for example, the A/D conversion circuits, the signal processing circuits, and the coordinate extraction circuits.

Each of the A/D conversion circuits samples an analog signal output from the display panel 20 and convert it into a digital signal at a time synchronized with the first drive signal VTP or the second drive signal VSELF.

Each of the signal processing circuits is a logic circuit that detects whether the display panel 20 is touched, based on the output signal of the A/D conversion circuit. The signal processing circuit performs processing of extracting a signal of difference (absolute value |ΔV|) in the detection signals caused by the finger. The signal processing circuit compares the absolute value |ΔV| with a predetermined threshold voltage, and determines that the detection target body is in a non-present state if the absolute value |ΔV| is lower than the threshold voltage. If, instead, the absolute value |ΔV| is equal to or higher than the threshold voltage, the signal processing circuit determines that the detection target body is in a present state.

Each of the coordinate extraction circuits is a logic circuit that obtains coordinates of the detection target body when the detection target body is detected by the signal processing circuit. The coordinate extraction circuit outputs the coordinates of the detection target body as output signals. The coordinate extraction circuit outputs the output signals to outside the display panel 20 (to, for example, the controller 200).

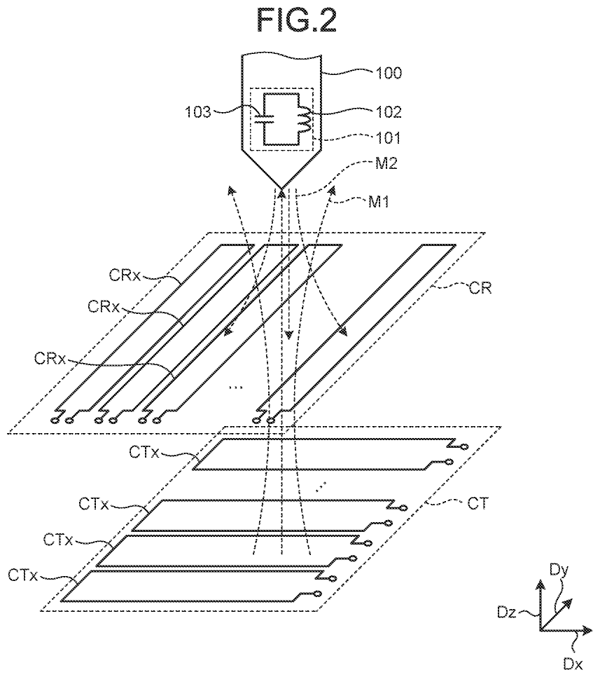

The following describes the touch detection using the electromagnetic induction method by the display panel 20 of the present embodiment with reference to FIG. 2. FIG. 2 is an explanatory diagram for explaining the electromagnetic induction touch detection.

As illustrated in FIG. 2, in the electromagnetic induction method, the contact or the proximity of the touch pen 100 is detected. A resonant circuit 101 is provided in the touch pen 100. The resonant circuit 101 is configured by coupling a coil 102 to a capacitive element 103 in parallel.

In the electromagnetic induction method, the transmitting coils CTx and the receiving coils CRx are provided so as to overlap each other. Each of the transmitting coils CTx has a longitudinal direction along a first direction Dx. Each of the receiving coils CRx has a longitudinal direction along a second direction Dy. Each receiving coil CRx is provided so as to intersect the transmitting coils CTx in a plan view. The transmitting coils CTx are coupled to the drive circuit 18, and the receiving coils CRx are coupled to the first detection circuit 11 (refer to FIG. 1).

As illustrated in FIG. 2, during a magnetic field generation period, the first detection control circuit 10 applies an alternating-current rectangular wave having a predetermined frequency (ranging, for example, roughly from several kilohertz to several hundred kilohertz) through the drive circuit 18 to the transmitting coils CTx. As a result, a current flows in the transmitting coils CTx, and the transmitting coils CTx generate a magnetic field M1 corresponding to the change in current. When the touch pen 100 is in contact with or in proximity to the display surface, an electromotive force is generated in the coil 102 by mutual induction between the transmitting coils CTx and the coil 102, whereby the capacitive element 103 is charged.

Then, during a magnetic field detection period, the coil 102 of the touch pen 100 generates a magnetic field M2 that varies with a resonant frequency of the resonant circuit 101. The magnetic field M2 passes through the receiving coils CRx, and as a result, an electromotive force is generated in the receiving coils CRx by mutual induction between the receiving coils CRx and the coil 102. A current corresponding to the electromotive force of the receiving coils CRx flows in the first detection circuit 11. The touch pen 100 is detected by scanning the transmitting coils CTx and the receiving coils CRx.

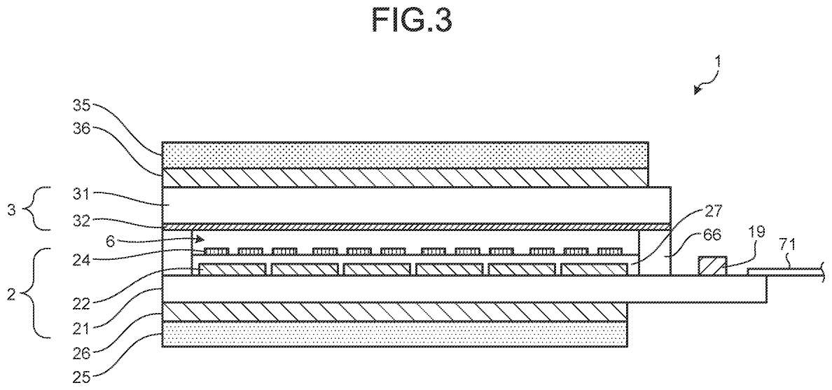

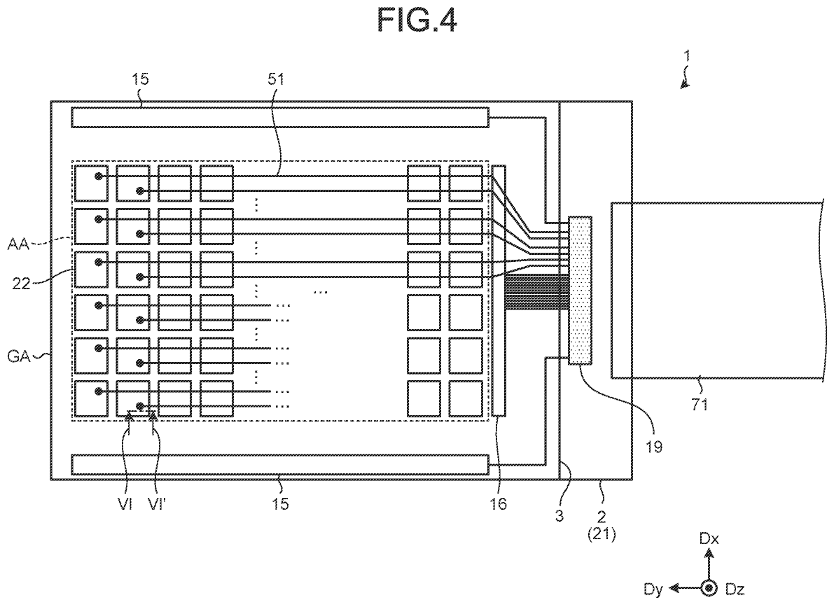

FIG. 3 is a sectional view illustrating a schematic structure of the display apparatus according to the first embodiment. FIG. 4 is a plan view schematically illustrating the display apparatus according to the first embodiment. As illustrated in FIG. 3, the display apparatus 1 includes an array substrate 2, a counter substrate 3, a liquid crystal layer 6, a polarizing plate 25, and a polarizing plate 35. The counter substrate 3 is disposed so as to be opposed to a surface of the array substrate 2 in the direction orthogonal thereto. The liquid crystal layer 6 is provided between the array substrate 2 and the counter substrate 3.

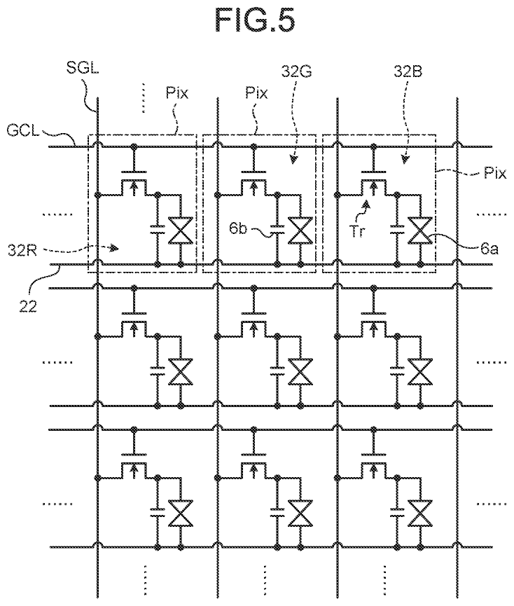

The array substrate 2 includes a first substrate 21, the detection electrodes 22, and pixel electrodes 24. The array substrate 2 is a drive circuit substrate for driving each of the pixels Pix, and is also called a back plane. The first substrate 21 is provided with circuits such as a gate scanner included in the gate driver 15, switching elements Tr such as thin-film transistors (TFTs), and various types of wiring such as gate lines GCL and the signal lines SGL (refer to FIG. 5). The pixel electrodes 24 are arranged in a matrix having a row-column configuration above one surface of the first substrate 21.

The detection electrodes 22 are provided between the first substrate 21 and the pixel electrodes 24. The pixel electrodes 24 are isolated from the detection electrodes 22 with an insulating layer 27 interposed therebetween. The polarizing plate 25 is provided to the other surface of the first substrate 21 with an adhesive layer 26 interposed therebetween. In the present embodiment, the case has been described where the pixel electrodes 24 are provided on the upper sides of the detection electrodes 22. However, the detection electrodes 22 may be provided on the upper sides of the pixel electrodes 24. In other words, the pixel electrodes 24 may be disposed between the first substrate 21 and the detection electrode 22.

The first substrate 21 is provided with the drive IC 19 and the wiring substrate 71. The drive IC 19 has all or some of the functions of the first detection control circuit 10, the second detection control circuit 12, and the display control circuit 14 illustrated in FIG. 1. The drive IC 19 may include two or more IC chips, and one or some of the IC chips may be disposed on the wiring substrate 71.

As illustrated in FIG. 3, the counter substrate 3 includes a second substrate 31 and a color filter 32. The color filter 32 is provided to a surface of the second substrate 31 opposed to the first substrate 21. The color filter 32 is opposed to the liquid crystal layer 6 in the direction orthogonal to the first substrate 21. The polarizing plate 35 is provided on the second substrate 31 with an adhesive layer 36 interposed therebetween. The first substrate 21 and the second substrate 31 are light-transmitting glass substrates capable of transmitting visible light. Alternatively, the first substrate 21 and the second substrate 31 may be light-transmitting resin substrates or resin films made of a resin such as polyimide. The color filter 32 may be provided to the first substrate 21.

The first substrate 21 is disposed opposed to the second substrate 31 with a predetermined gap provided therebetween by a seal portion 66. The liquid crystal layer 6 is provided in a space surrounded by the first substrate 21, the second substrate 31, and the seal portion 66. The liquid crystal layer 6 modulates light passing therethrough according to a state of an electric field, and is made using, for example, liquid crystals in a horizontal electric field mode, such as in-plane switching (IPS) including fringe field switching (FFS). The liquid crystal layer 6 is provided as a display layer for displaying an image. An orientation film is provided between the liquid crystal layer 6 and the array substrate 2 and between the liquid crystal layer 6 and the counter substrate 3 illustrated in FIG. 3.

In this specification, in a direction orthogonal to the surface of the first substrate 21, the term “upper side” refers to a direction from the first substrate 21 toward the second substrate 31, and the term “lower side” refers to a direction from the second substrate 31 toward the first substrate 21. The term “plan view” refers to a case of viewing from a direction orthogonal to the surface of the first substrate 21.

The first direction Dx and the second direction Dy are directions parallel to the surface of the first substrate 21. The first direction Dx is orthogonal to the second direction Dy. The first direction Dx may, however, non-orthogonally intersect the second direction Dy. A third direction Dz is a direction orthogonal to the surface of the first substrate 21. The third direction Dz is orthogonal to the first direction Dx and the second direction Dy.

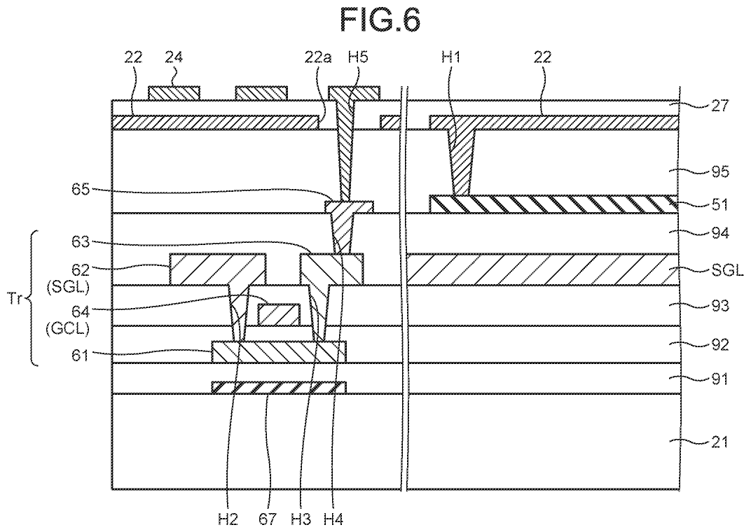

As illustrated in FIG. 4, an area corresponding to a display area AA of the display panel 20 and an area corresponding to a peripheral area GA provided outside the display area AA are formed on the first substrate 21. The display area AA is an area overlapping the pixels Pix. The display area AA is also an area including detection elements such as the detection electrodes 22 and the first electrodes 67 (refer to FIG. 6). In other words, the display area AA is an area that can detect whether the display surface is touched by, for example, the finger and/or the touch pen 100.

The detection electrodes 22 are arranged in a matrix having a row-column configuration in the display area AA. Each of the detection electrodes 22 is rectangular or square in the plan view. The detection electrode 22 is made of a light-transmitting electrically conductive material such as indium tin oxide (ITO). The detection electrode 22 may have another shape such as a polygonal shape.

Detection electrode lines 51 are electrically coupled to the respective detection electrodes 22. The plurality of detection electrode lines 51 extend in the second direction Dy and are arranged in the first direction Dx. In the present embodiment, the detection electrode lines 51 are provided in a layer different from that of the detection electrodes 22, and are provided in an area overlapping the detection electrodes 22 in the plan view. Each of the detection electrode lines 51 is coupled to the second detection circuit 13 included in the drive IC 19.

FIG. 5 is a circuit diagram illustrating a pixel array of the display apparatus according to the first embodiment. As illustrated in FIG. 5, the display panel 20 includes the pixels Pix arranged in a matrix having a row-column configuration. Each of the pixels Pix includes one of the switching elements Tr and a liquid crystal element 6a. The switching element Tr is formed of a thin-film transistor, and in the present example, formed of an n-channel metal oxide semiconductor (MOS) TFT. The insulating layer 27 is provided between the pixel electrodes 24 and the detection electrodes 22 (common electrodes), and these components generate retention capacitance 6b illustrated in FIG. 5.

The gate driver 15 illustrated in FIG. 1 sequentially selects the gate lines GCL. The gate driver 15 applies the scan signal Vscan to the gate of each of the switching elements Tr of the pixels Pix through the selected one of the gate lines GCL. This operation sequentially selects one row (one horizontal line) of the pixels Pix as the target of display driving. A source driver included in the display control circuit 14 supplies the pixel signal Vpix to each of the pixels Pix included in the selected one horizontal line through the signal lines SGL. These pixels Pix perform display of each horizontal line in response to the supplied pixel signals Vpix. In FIG. 4, the gate driver 15 is disposed in each of two areas of the peripheral area GA opposed to each other with the display area AA interposed therebetween. The gate driver 15 may, however, be disposed in either of the two areas.

In the color filter 32 illustrated in FIG. 3, for example, a color area 32R, a color area 32G, and a color area 32B of the color filter 32 colored in three colors of red (R), green (G), and blue (B) are periodically arranged. The color area 32R, the color area 32G, and the color area 32B of the three colors of R, G, and B are associated with each pixel Pix illustrated in FIG. 5. The color areas associated with each pixel Pix only need to be different colors, and may be a combination of other colors. The color areas associated with each pixel Pix are not limited to a combination of three colors, and may be a combination of four or more colors.

The detection electrodes 22 illustrated in FIGS. 3 and 4 serve as common electrodes that apply a common potential to the pixels Pix of the display panel 20, and also serve as drive electrodes and detection electrodes when the touch detection using the self-capacitance method is performed. During the display period, the display control circuit 14 supplies the display drive signal Vcomdc through the drive circuit 18 to the detection electrodes 22.

As an example of an operation method of the display apparatus 1, the display apparatus 1 performs the electromagnetic induction touch detection (first sensing period), the self-capacitive touch detection (second sensing period), and the display operation (display period) in a time-division manner. The touch detection operations and the display operation may be divided in any way.

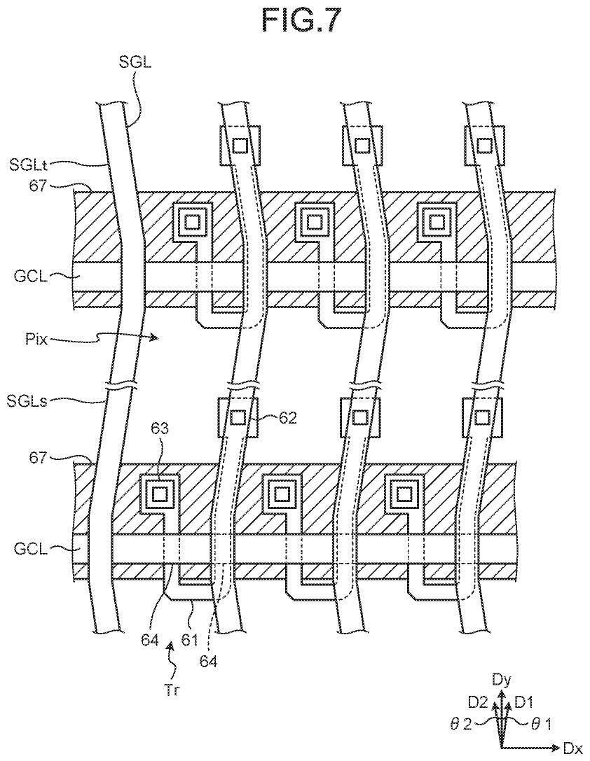

FIG. 6 is a VI-VI′ sectional view of FIG. 4. FIG. 7 is a plan view illustrating an enlarged view of the first electrodes according to the first embodiment. FIG. 6 also illustrates a sectional configuration of the switching element Tr provided in the pixels Pix.

As illustrated in FIG. 6, the switching element Tr includes a semiconductor 61, a source electrode 62, a drain electrode 63, and a gate electrode 64. The semiconductor 61 is provided on the first substrate 21 with a first insulating layer 91 interposed therebetween. The first insulating layer 91, a second insulating layer 92, a third insulating layer 93, and the insulating layer 27 are made using an inorganic insulating material such as a silicon oxide (SiO) film, a silicon nitride (SiN) film, or a silicon oxide nitride (SiON) film. Each of the inorganic insulating layers is not limited to a single layer, and may be a multi-layered film.

The second insulating layer 92 is provided on the first insulating layer 91 so as to cover the semiconductor 61. The gate electrode 64 is provided on the second insulating layer 92. The gate electrode 64 is a portion of the gate line GCL overlapping the semiconductor 61. The third insulating layer 93 is provided on the second insulating layer 92 so as to cover the gate electrode 64. A channel area is formed at a portion of the semiconductor 61 overlapping the gate electrode 64.

In the example illustrated in FIG. 6, the switching element Tr has what is called a top-gate structure. However, the switching element Tr may have a bottom-gate structure in which the gate electrode 64 is provided below the semiconductor 61. The switching element Tr may have a dual-gate structure in which the gate electrodes 64 are provided so as to interpose the semiconductor 61 therebetween in a direction orthogonal to the first substrate 21.

The semiconductor 61 is formed of, for example, amorphous silicon, a microcrystalline oxide semiconductor, an amorphous oxide semiconductor, polycrystalline silicon, low-temperature polycrystalline silicon (hereinafter, called LTPS), or gallium nitride (GaN).

The source electrode 62 and the drain electrode 63 are provided on the third insulating layer 93. In the present embodiment, the source electrode 62 is electrically coupled to the semiconductor 61 through a contact hole H2. The drain electrode 63 is electrically coupled to the semiconductor 61 through a contact hole H3. The source electrode 62 is a portion of each of the signal lines SGL overlapping the semiconductor 61.

A fourth insulating layer 94 and a fifth insulating layer 95 are provided on the third insulating layer 93 so as to cover the source electrode 62 and the drain electrode 63. The fourth insulating layer 94 and the fifth insulating layer 95 are planarizing layers that planarize asperities formed by the switching elements Tr and the various types of wiring.

A relay electrode 65 and the detection electrode lines 51 are provided on the fourth insulating layer 94. The relay electrode 65 is electrically coupled to the drain electrode 63 through a contact hole H4. The detection electrode lines 51 are provided on the upper sides of the signal lines SGL. The detection electrodes 22 are provided on the fifth insulating layer 95. The detection electrode 22 is electrically coupled to the detection electrode line 51 through a contact hole H1.

Each of the pixel electrodes 24 electrically coupled to the relay electrode 65 through a contact hole H5 provided in the insulating layer 27 and the fifth insulating layer 95. The contact hole H5 is formed in a position overlapping an opening 22a of the detection electrode 22. The above-described configuration couples the pixel electrodes 24 to the respective switching elements Tr.

Each of the first electrodes 67 is provided between the first substrate 21 and the semiconductor 61 in the direction orthogonal to the first substrate 21. In other words, the semiconductor 61 is provided between the first electrode 67 and the gate electrode 64 in the direction orthogonal to the first substrate 21. The first electrode 67 is made of a material having light transmittance lower than that of the first substrate 21, and is used as a light-shielding layer. For example, a metal material is used as the first electrode 67.

As illustrated in FIG. 7, in the signal line SGL, a first portion SGLs inclining along a direction D1 and a second portion SGLt inclining along a direction D2 are alternately coupled along the second direction Dy. The signal line SGL extends in the second direction Dy as a whole. The gate line GCL extends in the first direction Dx so as to intersect the signal lines SGL. For ease of viewing, FIG. 7 does not illustrate the pixel electrode 24 of each of the pixels Pix.

The direction D1 is a direction inclining by an angle θ1 with respect to the second direction Dy. The direction D2 is a direction inclined to a side opposite to a side to which the direction D1 is inclined with respect to the second direction Dy. The angle formed between the direction D2 and the second direction Dy is an angle θ2. The angle θ1 equals the angle θ2. The angle θ1 may, however, differ from the angle θ2.

The first electrode 67 extends along the gate line GCL in the first direction Dx, and is provided below the gate line GCL and the switching elements Tr. The first electrode 67 is continuously provided across the pixels Pix and the switching elements Tr arranged in the first direction Dx. The first electrode 67 serves as the light-shielding layer, and only needs to be provided at least below a part where the semiconductor 61 intersects the gate line GCL. This configuration allows the first electrode 67 to reduce a light leakage current of the switching elements Tr.

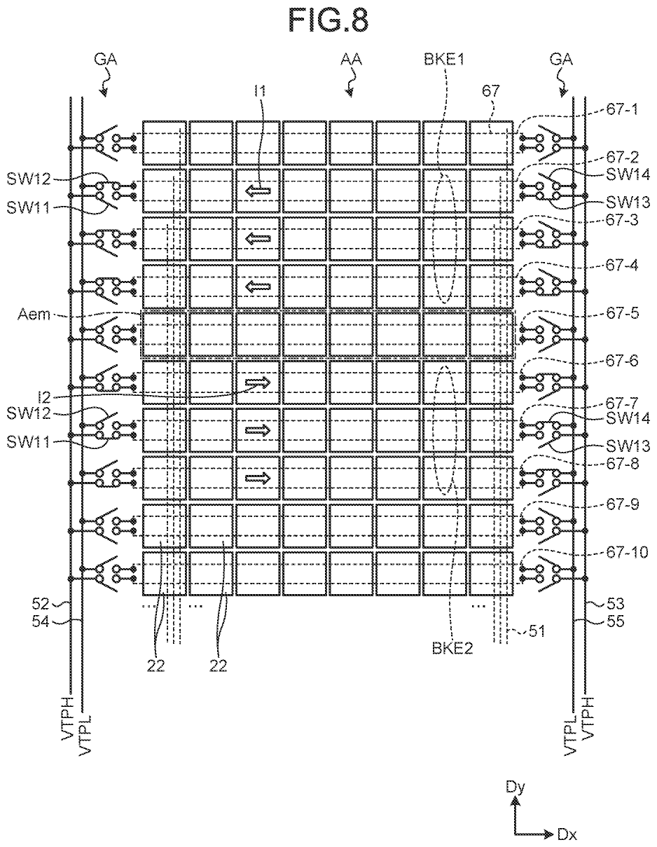

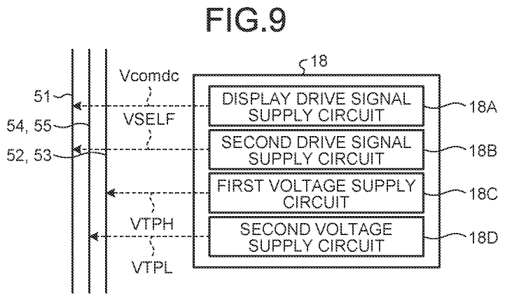

FIG. 8 is a circuit diagram illustrating a coupling configuration of the first electrodes according to the first embodiment. FIG. 9 is a block diagram illustrating the drive circuit that supplies various signals. FIG. 8 illustrates the coupling configuration of the first electrodes during the first sensing period.

As illustrated in FIG. 8, a plurality of first electrodes 67-1, 67-2, . . . , 67-10 are arranged in the second direction Dy. In the following description, the first electrodes 67-1, 67-2, . . . , 67-10 will each be referred to as the first electrode 67 when they need not be distinguished from one another. In the following description, a first end of the first electrode 67 will be referred to as the left end, and a second end thereof will be referred to as the right end, with reference to FIG. 8.

A first drive signal supply line 52 and a second drive signal supply line 54 are provided on the left end sides of the first electrodes 67, and first drive signal supply line 53 and second drive signal supply line 55 are provided on the right end sides of the first electrodes 67. The first drive signal supply lines 52, 53 and the second drive signal supply lines 54, 55 are wiring for supplying the first drive signal VTP to the first electrodes 67.

A switch SW11 is provided between the left end of each of the first electrodes 67 and the first drive signal supply line 52. A switch SW12 is provided between the left end of each of the first electrodes 67 and the second drive signal supply line 54. The switch SW11 and the switch SW12 are coupled in parallel to the left end of the first electrode 67.

A switch SW13 is provided between the right end of each of the first electrodes 67 and the first drive signal supply line 53. A switch SW14 is provided between the right end of each of the first electrodes 67 and the second drive signal supply line 55. The switch SW13 and the switch SW14 are coupled in parallel to the right end of the first electrode 67. The first drive signal supply lines 52, 53, the second drive signal supply lines 54, 55, and the switches SW11 to SW14 are provided in the peripheral area GA. The first drive signal supply lines 52, 53, the second drive signal supply lines 54, 55, and the switches SW11 to SW14 are coupling members that couple the ends of the first electrodes 67 to one another.

As illustrated in FIG. 9, the drive circuit 18 supplies the various signals through the detection electrode lines 51, the first drive signal supply lines 52, 53, and the second drive signal supply lines 54, 55 to the detection electrodes 22 and the first electrodes 67. The drive circuit 18 includes a display drive signal supply circuit 18A, a second drive signal supply circuit 18B, a first voltage supply circuit 18C, and a second voltage supply circuit 18D. The display drive signal supply circuit 18A, the second drive signal supply circuit 18B, the first voltage supply circuit 18C, and the second voltage supply circuit 18D are provided in the drive IC 19 (refer to FIG. 1). At least one of the display drive signal supply circuit 18A, the second drive signal supply circuit 18B, the first voltage supply circuit 18C, and the second voltage supply circuit 18D may be provided as a circuit on the display panel 20.

The display drive signal supply circuit 18A supplies the display drive signal Vcomdc through the detection electrode lines 51 to the detection electrodes 22. The second drive signal supply circuit 18B supplies the second drive signal VSELF for detection through the detection electrode lines 51 to the detection electrodes 22. The first voltage supply circuit 18C supplies a first voltage VTPH of a direct current having a first potential through the first drive signal supply lines 52, 53 to the first electrodes 67. The second voltage supply circuit 18D supplies a second voltage VTPL through the second drive signal supply lines 54, 55 to the first electrodes 67. The second voltage VTPL is a direct-current voltage signal having a second potential lower than the first potential.

As illustrated in FIG. 8, during the first sensing period, in response to a control signal from the first detection control circuit 10, the switches SW11, SW12, SW13, and SW14 operate to select the first electrodes 67 that form the transmitting coil CTx. Specifically, the first electrodes 67-2, 67-3, and 67-4 and the first electrodes 67-6, 67-7, and 67-8 are selected as first electrode blocks BKE1 and BKE2. The other first electrodes 67 serve as a non-selected electrode block. An area between the first electrode 67-4 and the first electrode 67-6 serves as a detection area Aem for detecting the detection target body.

On the left sides of the first electrodes 67-2, 67-3, and 67-4, the switches SW11 are turned off, and the switches SW12 are turned on. As a result, the left ends of the first electrodes 67-2, 67-3, and 67-4 are electrically coupled to the second drive signal supply line 54. On the right sides of the first electrodes 67-2, 67-3, and 67-4, the switches SW13 are turned on, and the switches SW14 are turned off. As a result, the right ends of the first electrodes 67-2, 67-3, and 67-4 are electrically coupled to the first drive signal supply line 53.

On the left sides of the first electrodes 67-6, 67-7, and 67-8, the switches SW11 are turned on, and the switches SW12 are turned off. As a result, the left ends of the first electrodes 67-6, 67-7, and 67-8 are electrically coupled to the first drive signal supply line 52. On the right sides of the first electrodes 67-6, 67-7, and 67-8, the switches SW13 are turned off, and the switches SW14 are turned on. As a result, the right ends of the first electrodes 67-6, 67-7, and 67-8 are electrically coupled to the second drive signal supply line 55.

As a result, during the first sensing period, the second voltage supply circuit 18D is coupled to the left end sides of the first electrodes 67-2, 67-3, and 67-4, and the first voltage supply circuit 18C is coupled to the right end sides thereof. In addition, the first voltage supply circuit 18C is coupled to the left end sides of the first electrodes 67-6, 67-7, and 67-8, and the second voltage supply circuit 18D is coupled to the right end sides thereof.

The second voltage supply circuit 18D supplies the second voltage VTPL through the second drive signal supply line 54 to the left ends of the first electrodes 67-2, 67-3, and 67-4. The first voltage supply circuit 18C supplies the first voltage VTPH through the first drive signal supply line 53 to the right ends of the first electrodes 67-2, 67-3, and 67-4. As a result, potential differences are generated between the left ends and the right ends of the first electrodes 67-2, 67-3, and 67-4 to cause currents I1 to flow in a direction from the right ends toward the left ends thereof.

The first voltage supply circuit 18C supplies the first voltage VTPH through the first drive signal supply line 52 to the left ends of the first electrodes 67-6, 67-7, and 67-8. The second voltage supply circuit 18D supplies the second voltage VTPL through the second drive signal supply line 55 to the right ends of the first electrodes 67-6, 67-7, and 67-8. As a result, potential differences are generated between the left ends and the right ends of the first electrodes 67-6, 67-7, and 67-8 to cause currents I2 to flow in a direction from the left ends toward the right ends thereof.

The first detection control circuit 10 switches the operations of the switches SW11, SW12, SW13, and SW14 to change the first voltage VTPH and the second voltage VTPL to be supplied to both ends of the first electrodes 67 at a predetermined frequency. This causes the drive circuit 18 to supply the first drive signal VTP serving as an alternating-current voltage signal to the first electrodes 67 during the first sensing period.

The currents I1 and I2 flowing through the first electrodes 67 generate a magnetic field to cause the electromagnetic induction. The currents I1 and the currents I2 flow in directions opposite to each other. As a result, the magnetic field generated by the currents I1 overlaps the magnetic field generated by the currents I2 in the detection area Aem. This overlap can increase the strength of the magnetic field passing through the detection area Aem. The magnetic field generated by the currents I1 and the currents I2 corresponds to the magnetic field M1 generated during the magnetic field generation period of the electromagnetic induction method illustrated in FIG. 2. The first electrodes 67-2, 67-3, and 67-4 included in the first electrode block BKE1 and the first electrodes 67-6, 67-7, and 67-8 included in the first electrode block BKE2 correspond to the transmitting coil CTx.

In FIG. 8, the switches SW11 and SW12 and the switches SW13 and SW14 for the first electrodes 67 (the first electrodes 67-1, 67-5, 67-9, 67-10) in the non-selected electrode block are turned off. This operation brings the first electrodes 67 in the non-selected electrode block into a floating state.

The first detection control circuit 10 sequentially selects the first electrode 67-1 to the first electrode 67-10. As a result, the touch detection is performed over the entire display area AA using the electromagnetic induction method. The first electrodes 67 may also be provided in the peripheral area GA. This configuration can also generate magnetic fields in the peripheral portion of the display area AA.

In FIG. 8, the transmitting coil CTx is formed by six of the first electrodes 67. The transmitting coil CTx is, however, not limited to this configuration, and may be formed by one or two of the first electrodes 67 disposed on one side of the detection area Aem and one or two of the first electrodes 67 disposed on the other side of the detection area Aem. The transmitting coil CTx may be formed by four or more of the first electrodes 67 disposed on one side of the detection area Aem and four or more of the first electrodes 67 disposed on the other side of the detection area Aem. The numbers of the first electrodes 67 for forming the coil need not be the same between the one side and the other side of the detection area Aem. A configuration can be employed in which the number of the first electrodes 67 on one side differs from that of the first electrodes 67 on the other side. The number of the first electrodes 67 disposed between first electrodes 67 through which the currents flow in different directions, that is, between the first electrodes 67 through which the currents I1 flow and the first electrodes 67 through which the currents I2 flow is not limited to one, and may be zero or an integer of two or greater.

As described above, the display apparatus 1 includes the first drive signal supply lines 52, 53 that supply the first voltage VTPH to the first electrodes 67 and the second drive signal supply lines 54, 55 that supply the second voltage VTPL lower than the first voltage VTPH to the first electrodes 67. During the first sensing period, the first drive signal supply line 52 is coupled to the first end side of at least one of the first electrodes 67, and the second drive signal supply line 55 is coupled to the second end side thereof. In addition, the second drive signal supply line 54 is coupled to the first end sides of the first electrodes 67 other than the at least one of the first electrodes 67, and the first drive signal supply line 53 is coupled to the second end sides thereof.

During the display period, the display drive signal supply circuit 18A supplies the display drive signal Vcomdc through the detection electrode lines 51 to the detection electrodes 22. During the display period, all the switches SW11, SW12, SW13, and SW14 are turned off in response to the control signal from the first detection control circuit 10. As a result, all the first electrodes 67 are uncoupled from the first drive signal supply lines 52, 53 and the second drive signal supply lines 54, 55 to be brought into the floating state.

During the self-capacitive detection period, the second drive signal supply circuit 18B supplies the second drive signal VSELF for detection through the detection electrode lines 51 to the detection electrodes 22. The detection electrodes 22 output a signal (second detection signal Vdet2) corresponding to a change in the self-capacitance caused by the contact or the proximity of the detection target body to the second detection circuit 13. In this case, the first detection control circuit 10 turns on all the switches SW11 and SW13 and turns off all the switches SW12 and SW14. The second drive signal supply circuit 18B supplies a guard drive signal through the first drive signal supply lines 52, 53 to all the first electrodes 67. The guard drive signal is a voltage signal synchronized with the second drive signal VSELF and having the same amplitude as the second drive signal VSELF. This operation can restrain capacitance coupling between the detection electrodes 22 and the first electrodes 67.

The coupling configuration illustrated in FIG. 8 is merely an example and can be modified as appropriate. For example, during the first sensing period, the first voltage supply circuit 18C and the second voltage supply circuit 18D may respectively supply the first voltage VTPH and the second voltage VTPL only to the left ends of the first electrodes 67. The second voltage supply circuit 18D supplies the second voltage VTPL through the second drive signal supply line 54 to the left ends of the first electrodes 67-2, 67-3, and 67-4. The first voltage supply circuit 18C supplies the first voltage VTPH through the first drive signal supply line 52 to the left ends of the first electrodes 67-6, 67-7, and 67-8.

The right ends of the first electrodes 67-2, 67-3, and 67-4 are electrically coupled to the right ends of the first electrodes 67-6, 67-7, and 67-8 through at least one of the first drive signal supply line 53 and the second drive signal supply line 55. Also in this case, the first electrodes 67-2, 67-3, and 67-4 and the first electrodes 67-6, 67-7, and 67-8 are formed into the transmitting coil CTx.

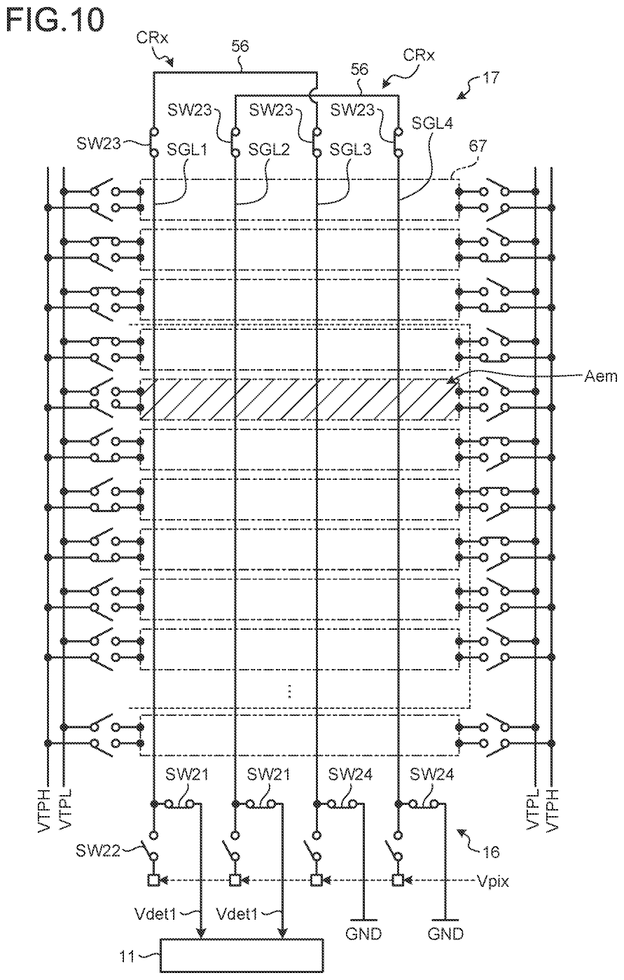

FIG. 10 is a circuit diagram illustrating a coupling configuration of the signal lines according to the first embodiment. FIG. 10 illustrates four signal lines SGL1, SGL2, SGL3, and SGL4 among the signal lines SGL. In the following description, the signal lines SGL1, SGL2, SGL3, and SGL4 will each be referred to as the signal line SGL when they need not be distinguished from one another. FIG. 10 illustrates each of the first electrodes 67 with a long dashed double-short dashed line.

As illustrated in FIG. 10, the signal lines SGL are provided so as to intersect the first electrodes 67 in the plan view. The first coupling switching circuit 16 is provided on one side of each of the signal lines SGL1, SGL2, SGL3, and SGL4, and the second coupling switching circuit 17 is provided on the other side thereof. The first coupling switching circuit 16 is a switching circuit including switches SW21, SW22, and SW24. The second coupling switching circuit 17 is a switching circuit including switches SW23 and signal line coupling lines 56. In the following description, a first end of the signal line SGL will be referred to as a lower end, and a second end thereof will be referred to as an upper end, with reference to FIG. 10.

In the first coupling switching circuit 16, the switches SW21 switch between coupling and uncoupling the signal lines SGL1 and SGL2 and the first detection circuit 11. The switches SW22 switch between coupling and uncoupling the signal lines SGL and the display control circuit 14. The switches SW24 switch between coupling and uncoupling the signal lines SGL3 and SGL4 and a reference potential (for example, a ground potential GND).

In the second coupling switching circuit 17, the switches SW23 and the signal line coupling line 56 switch between coupling and uncoupling the upper ends of a pair of the signal lines SGL1 and SGL3, and the switches SW23 and the signal line coupling line 56 switch between coupling and uncoupling the upper ends of a pair of the signal lines SGL2 and SGL4.

During the first sensing period, the switches SW23 are turned on in response to the control signal from the first detection control circuit 10. As a result, the upper ends of the pair of the signal lines SGL1 and SGL3 are coupled to each other through the signal line coupling line 56. In the same manner, the upper ends of the pair of the signal lines SGL2 and SGL4 are coupled to each other through the signal line coupling line 56. On the lower end sides of the signal lines SGL, the switches SW22 are turned off, and the switches SW21 and SW24 are turned on. As a result, the lower ends of the signal line SGL1 and the signal line SGL2 are each coupled to the first detection circuit 11. In addition, the lower ends of the signal line SGL3 and the signal line SGL4 are coupled to the reference potential (for example, the ground potential GND).

As described above, the first coupling switching circuit 16 couples a first end side of at least one of the signal lines SGL to the first detection circuit 11 during the first sensing period. The second coupling switching circuit 17 couples the second end sides of a plurality of the signal lines SGL to each other during the first sensing period.

With the above-described configuration, the signal lines SGL1 and SGL3 are coupled to form a loop as the receiving coil CRx. In addition, the signal lines SGL2 and SGL4 are coupled to form a loop as the receiving coil CRx. The receiving coils CRx are provided so as to overlap the detection area Aem formed by the first electrodes 67. The receiving coils CRx may be formed by signal line blocks each including a plurality of the signal lines SGL, in the same manner as the transmitting coil CTx illustrated in FIG. 8.

When the magnetic field M2 from the touch pen 100 (refer to FIG. 2) passes through an area surrounded by the pair of the signal lines SGL1 and SGL3 and the signal line coupling line 56 or an area surrounded by the pair of the signal lines SGL2 and SGL4 and the signal line coupling line 56, an electromotive force corresponding to a variation in the magnetic field M2 is generated in each of the receiving coils CRx. The first detection signal Vdet1 corresponding to this electromotive force is supplied to the first detection circuit 11. In this manner, during the first sensing period, the first electrodes 67 are supplied with the first drive signal VTP from the drive circuit 18 to generate a magnetic field, and an electromotive force due to the magnetic field is generated in the signal lines SGL. Thus, the display apparatus 1 can detect the touch pen 100.

In the present embodiment, the adjacent receiving coils CRx are arranged so as to partially overlap each other. Specifically, the area surrounded by the pair of the signal lines SGL1 and SGL3 and the signal line coupling line 56 forming one receiving coil CRx includes the signal line SGL2 of the other of the receiving coil CRx. In addition, the area surrounded by the pair of the signal lines SGL2 and SGL4 and the signal line coupling line 56 forming the other receiving coil CRx includes the signal line SGL3 of the one receiving coil CRx. This configuration can restrain generation of an area in the display area AA where detection sensitivity of magnetic fields is reduced, or an insensitive area in the display area AA where magnetic fields cannot be detected.

During the display period, the switches SW23 are turned off in response to the control signal from the first detection control circuit 10. As a result, the upper ends of the signal lines SGL1, SGL2, SGL3, and SGL4 are uncoupled from one another. The switches SW21 and SW24 are turned off, and the switches SW22 are turned on. As a result, the lower ends of the signal lines SGL1, SGL2, SGL3, and SGL4 are uncoupled from the first detection circuit 11 and the reference potential (for example, the ground potential GND). The pixel signals Vpix are supplied through the switches SW22 to the signal lines SGL.

During the second sensing period, the second detection control circuit 12 may supply the guard drive signal to the signal lines SGL. Alternatively, the second detection control circuit 12 may bring the signal lines SGL into the floating state.

The first electrodes 67 forming the transmitting coils CTx are a metal material having a higher electrical conductivity than the detection electrodes 22, and have a significantly lower resistance than the detection electrodes 22. As a result, it is possible, by using the first electrodes 67 as the drive electrodes (transmitting coils CTx), to hamper the first drive signal VTP as the alternating-current rectangular wave from being rounded. As a result, in the present embodiment, responsiveness to the first drive signal VTP is increased and the detection sensitivity is improved in the electromagnetic induction touch detection.

### Second Embodiment

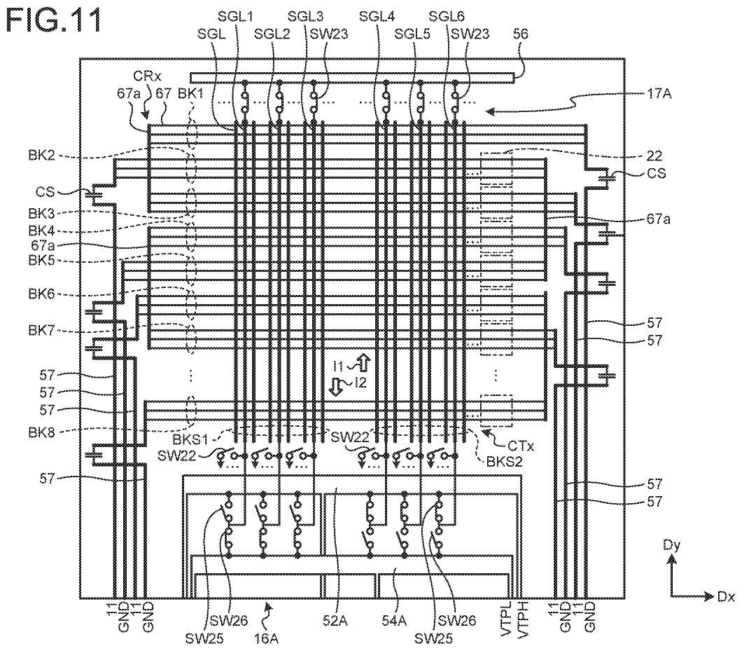

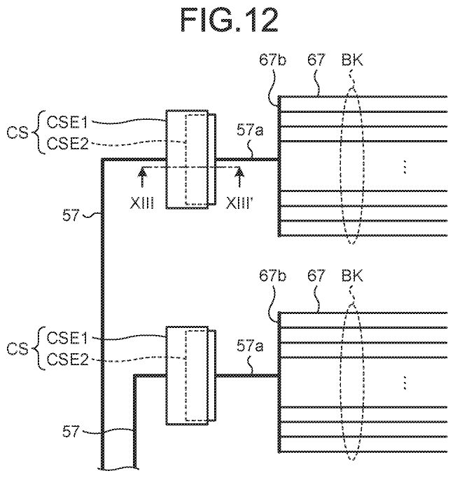

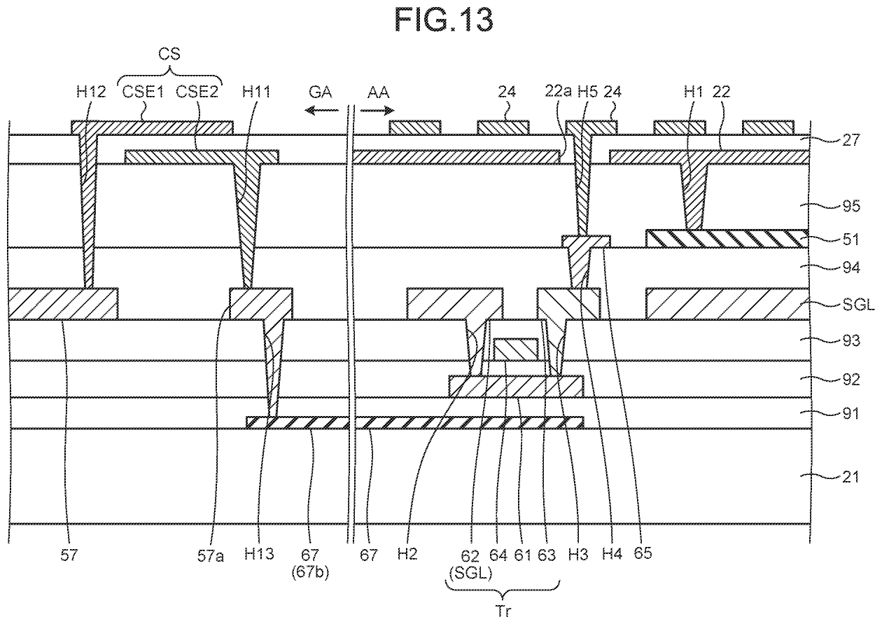

FIG. 11 is a circuit diagram illustrating a coupling configuration of the first electrodes and the signal lines according to a second embodiment of the present disclosure. FIG. 12 is a plan view illustrating an enlarged view of a coupling portion between the first electrodes and detection signal output lines according to the second embodiment. FIG. 13 is a XIII-XIII′ sectional view of FIG. 12. FIG. 13 also illustrates a multi-layered configuration of the switching element Tr provided in the pixel Pix. In the following description, the components described in the above-described embodiment will be denoted by the same reference numerals, and will not be described.

In the present embodiment, during the first sensing period, the signal lines SGL are supplied with the first drive signal VTP from the drive circuit 18 to generate a magnetic field, and an electromotive force due to the magnetic field is generated in the first electrodes 67. That is, the signal lines SGL form the transmitting coils CTx, and the first electrodes 67 form the receiving coils CRx.

As illustrated in FIG. 11, the signal lines SGL extend in the second direction Dy and are arranged in the first direction Dx. The signal lines SGL including the signal lines SGL1, SGL2, and SGL3 serve as a signal line block BKS1. The signal lines SGL including signal lines SGL4, SGL5, and SGL6 serve as a signal line block BKS2. The lower end sides of the signal line blocks BKS1 and BKS2 are provided with first drive signal supply line 52A and second drive signal supply line 54A. The lower end sides of the signal line block BKS1 and the signal line block BKS2 are provided with a first coupling switching circuit 16A, and the upper end sides thereof are provided with a second coupling switching circuit 17A.

The first coupling switching circuit 16A is a switching circuit including switches SW22, SW25, and SW26. The switches SW22 switch between coupling and uncoupling the signal lines SGL and the display control circuit 14. The switches SW25 switch between coupling and uncoupling the lower ends of the signal lines SGL and the first drive signal supply line 52A. The switches SW26 switch between coupling and uncoupling the lower ends of the signal lines SGL and the second drive signal supply line 54A.

As in the first embodiment, the second coupling switching circuit 17A switches between coupling and uncoupling the upper ends of a pair of the signal line block BKS1 and the signal line block BKS2. The switches such as the switches SW22, SW23, SW25, and SW26 are only partially illustrated, but are provided for each of the signal lines SGL.

During the first sensing period, the switches SW23 are turned on to couple the upper ends of the signal line block BKS1 and the signal line block BKS2 together through the signal line coupling line 56. On the lower end side of the signal line block BKS1, the switches SW26 are turned on, and the switches SW25 are turned off. On the lower end side of the signal line block BKS2, the switches SW26 are turned off, and the switches SW25 are turned on.

The first voltage supply circuit 18C (refer to FIG. 9) supplies the first voltage VTPH through the first drive signal supply line 52A to the lower end of the signal line block BKS2. The second voltage supply circuit 18D (refer to FIG. 9) supplies the second voltage VTPL through the second drive signal supply line 54A to the lower end of the signal line block BKS1. As a result, a potential difference is generated between the lower end of the signal line block BKS1 and the lower end of the signal line block BKS2 in paths formed by the signal line block BKS1, the signal line coupling line 56, and the signal line block BKS2. The potential difference causes the currents I1 and 12 to flow through the signal line block BKS2 and the signal line block BKS1, respectively.

The first detection control circuit 10 switches the operations of the switches SW25 and SW26 to change the first voltage VTPH and the second voltage VTPL to be supplied to the lower ends of the signal line blocks BKS1 and BKS2 at a predetermined frequency. Thus, the first drive signal VTP serving as the alternating-current voltage signal is supplied to the signal line blocks BKS1 and BKS2. The first detection control circuit 10 sequentially selects the signal lines SGL that serve as the signal line blocks BKS1 and BKS2. As a result, the touch detection is performed over the entire display area AA using the electromagnetic induction method.

As described above, the display apparatus 1 includes the first drive signal supply line 52A that supplies the first voltage VTPH to the signal lines SGL and the second drive signal supply line 54A that supplies the second voltage VTPL lower than the first voltage VTPH to the signal lines SGL. During the first sensing period, the first coupling switching circuit 16A couples the first drive signal supply line 52A to the first end side of at least one of the signal lines SGL, and couples the second drive signal supply line 54A to the first end sides of the signal lines SGL other than the at least one of the signal lines SGL. During the first sensing period, the second coupling switching circuit 17A couples the second end sides of the signal lines SGL to one another.

Also in the present embodiment, the signal lines SGL forming the transmitting coils CTx are a metal material having a higher electrical conductivity than the detection electrodes 22. As a result, in the present embodiment, the responsiveness to the first drive signal VTP is increased and the detection sensitivity is improved in the electromagnetic induction touch detection.

The first electrodes 67 extend in the first direction Dx, and are arranged in the second direction Dy. First electrode blocks BK1, BK2, . . . , BK8 each include a plurality of the first electrodes 67. The left end of the first electrode block BK1 is coupled to the left end of the first electrode block BK3 through first electrode coupling line 67a provided in the peripheral area GA. One of the right end of the first electrode block BK1 and the right end of the first electrode block BK3 is coupled to the reference potential (for example, the ground potential GND), and the other thereof is coupled to the first detection circuit 11, through a capacitor CS and a detection signal output line 57. This configuration causes the first electrode block BK1, the first electrode block BK3, and the first electrode coupling lines 67a to form the receiving coil CRx.

In the same manner, the right end of the first electrode block BK2 is coupled to the right end of the first electrode block BK5 through the first electrode coupling line 67a provided in the peripheral area GA. One of the left end of the first electrode block BK2 and the left end of the first electrode block BK5 is coupled to the reference potential (for example, the ground potential GND), and the other thereof is coupled to the first detection circuit 11 through the capacitor CS and the detection signal output line 57. This configuration causes the first electrode block BK2, the first electrode block BK5, and the first electrode coupling line 67a to form the receiving coil CRx.

As illustrated in FIG. 12, each of the first electrode blocks BK forming the receiving coils CRx is provided with the capacitor CS. The capacitor CS includes a first capacitor electrode CSE1 and a second capacitor electrode CSE2. The first capacitor electrode CSE1 and the second capacitor electrode CSE2 are provided so as to overlap each other in the plan view with a dielectric material (insulating layer 27) interposed therebetween.

The second capacitor electrode CSE2 is coupled to an end of the first electrode block BK through relay line 57a. The first electrodes 67 in the first electrode block BK are coupled together through first electrode coupling line 67b. The first capacitor electrode CSE1 is coupled to the detection signal output line 57.

As illustrated in FIG. 13, the first electrode 67 is provided between the first substrate 21 and the semiconductor 61 in the display area AA, and extends to the peripheral area GA. The capacitor CS and the detection signal output line 57 are provided in the peripheral area GA. The first capacitor electrode CSE1 is provided in the same layer as that of the pixel electrode 24 on the insulating layer 27. The second capacitor electrode CSE2 is provided in the same layer as that of the detection electrode 22 on the fifth insulating layer 95. The first capacitor electrode CSE1 is opposed to the second capacitor electrode CSE2 with the insulating layer 27 interposed therebetween in the direction orthogonal to the first substrate 21. This configuration provides capacitance between the first capacitor electrode CSE1 and the second capacitor electrode CSE2. The layers in which the first capacitor electrode CSE1 and the second capacitor electrode CSE2 are formed may be reversed. That is, the second capacitor electrode CSE2 may be formed in the same layer as that of the pixel electrode 24, and the first capacitor electrode CSE1 may be formed in the same layer as that of the detection electrode 22.

The second capacitor electrode CSE2 is coupled to the relay line 57a through a contact hole H11. The relay line 57a is coupled to the first electrode 67 through a contact hole H13. The first capacitor electrode CSE1 is coupled to the detection signal output line 57 through a contact hole H12. The detection signal output line 57 and the relay line 57a are provided in the same layer as that of the signal line SGL.

The above-described configuration provides the capacitor CS between each of the first electrode blocks BK and the first detection circuit 11. The capacitor CS reduces current leakage of the switching elements Tr, and provides good display performance.

### Third Embodiment

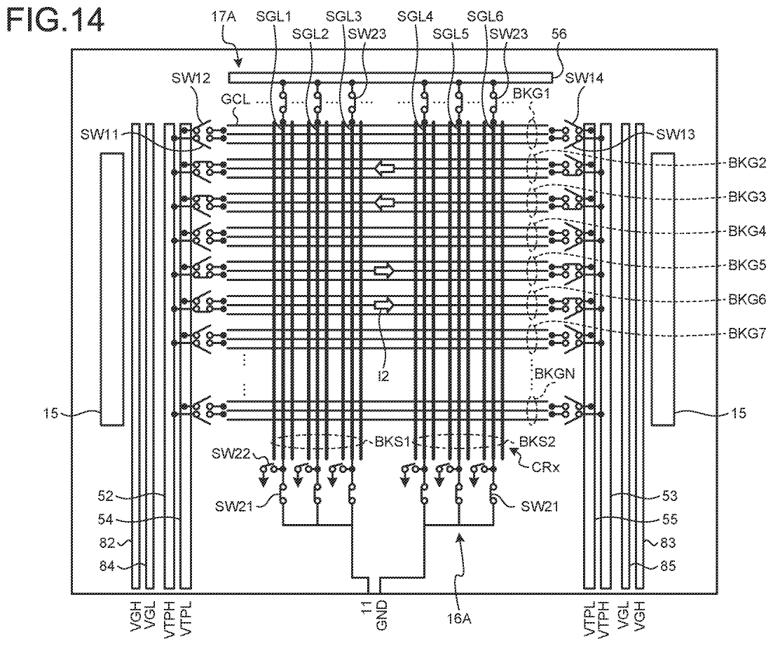

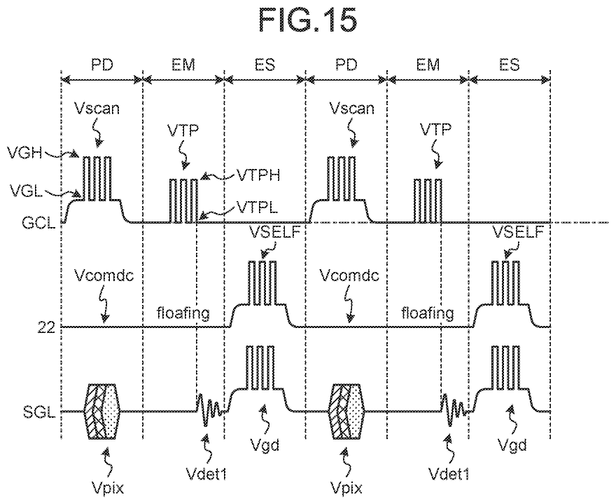

FIG. 14 is a circuit diagram illustrating a coupling configuration of the gate lines and the signal lines according to a third embodiment of the present disclosure. FIG. 15 is a timing waveform diagram illustrating an operation example of the display apparatus according to the third embodiment. In the present embodiment, during the first sensing period, the gate lines GCL are supplied with the first drive signal VTP from the drive circuit 18 to generate a magnetic field, and an electromotive force due to the magnetic field is generated in the signal lines SGL. That is, the gate lines GCL form the transmitting coils CTx, and the signal lines SGL form the receiving coils CRx.

The gate lines GCL extend in the first direction Dx, and are arranged in the second direction Dy. In the following description, a first end of the gate line GCL will be referred to as the left end, and a second end thereof will be referred to as the right end, with reference to FIG. 14. Gate line blocks BKG1, BKG2, . . . , BKGN each include a plurality of the gate lines GCL.

The first drive signal supply line 52, the second drive signal supply line 54, and the switches SW11 and SW12 are provided on the left end sides of the gate lines GCL. The first drive signal supply line 53, the second drive signal supply line 55, and the switches SW13 and SW14 are provided on the right end sides of the gate lines GCL. The coupling configuration and the operations of these components are the same as those in the example illustrated in FIG. 8 for the first embodiment. That is, during the first sensing period, the first drive signal supply lines 52 and 53 are coupled to the first end side of at least one of the gate lines GCL, and the second drive signal supply lines 54 and 55 are coupled to the second end side thereof. The second drive signal supply lines 54 and 55 are coupled to the first end sides of the gate lines GCL other than the at least one of the gate lines GCL, and the first drive signal supply lines 52 and 53 are coupled to the second end sides thereof. FIG. 14 only illustrates some of the switches SW11, SW12, SW13, and SW14. The switches SW11, SW12, SW13, and SW14 are provided for each of the gate lines GCL included in each of the gate line blocks BKG1, BKG2, . . . , BKGN.

In FIG. 14, the gate line blocks BKG2, BKG3, BKG5, and BKG6 form the transmitting coil CTx. During the first sensing period, the first detection control circuit 10 switches the operations of the switches SW11, SW12, SW13, and SW14 to change the first voltage VTPH and the second voltage VTPL to be supplied to both ends of the gate lines GCL at a predetermined frequency. Thus, the first drive signal VTP serving as the alternating-current voltage signal is supplied to the gate line blocks BKG2, BKG3, BKG5, and BKG6. The non-selected gate line blocks BKG1, BKG4, BKG7, . . . , BKGN not selected as the transmitting coil CTx are brought into the floating state.

The gate lines GCL are formed of a metal material. For example, copper (Cu) or aluminum (Al) is used as the gate lines GCL. As a result, the responsiveness to the first drive signal VTP is increased and the detection sensitivity is improved in the electromagnetic induction touch detection of the display apparatus 1.

Moreover, first gate drive signal supply line 82 and second gate drive signal supply line 84 are provided on the left end side of the gate lines GCL, and first gate drive signal supply line 83 and second gate drive signal supply line 85 are provided on the right end side thereof. The first gate drive signal supply lines 82 and 83 are wiring that supplies a high-level voltage VGH of the scan signal Vscan (refer to FIG. 1) to the gate lines GCL. The second gate drive signal supply lines 84 and 85 are wiring that supplies a low-level voltage VGL of the scan signal Vscan to the gate lines GCL.

During the display period, all the switches SW11, SW12, SW13, and SW14 are turned off. The gate lines GCL are sequentially coupled to the first gate drive signal supply lines 82 and 83 and the second gate drive signal supply lines 84 and 85 by the gate driver 15, and are supplied with the scan signal Vscan.

During a first sensing period EM, the upper ends of the signal line blocks BKS1 and BKS2 are coupled to each other through the switches SW23 and the signal line coupling line 56. One of the lower ends of the signal line blocks BKS1 and BKS2 is coupled to the reference potential (for example, the ground potential GND), and the other thereof is coupled to the first detection circuit 11, through the switches SW21. As a result, the signal line blocks BKS1 and BKS2 and the signal line coupling line 56 form the receiving coil CRx. Although FIG. 14 illustrates one of the receiving coils CRx, a plurality of the receiving coils CRx may be disposed so as to overlap one another in the same manner as in FIG. 10.

As illustrated in FIG. 15, the display apparatus 1 performs processing during a display period PD, during the first sensing period EM, and during a second sensing period ES in a time-division manner. The display period PD is a period in which the display panel 20 performs the display. The first sensing period EM is a period in which the electromagnetic induction touch detection is performed. The second sensing period ES is a period in which the self-capacitive touch detection is performed. The display apparatus 1 repeats the processing in the display period PD, the first sensing period EM, the second sensing period ES, the display period PD, the first sensing period EM, the second sensing period ES, and so on. However, the order and the number of times of the respective periods can be modified as appropriate.

As illustrated in FIG. 15, during the display period PD, the scan signal Vscan is supplied from the gate driver 15 to the gate lines GCL. The display control circuit 14 (refer to FIG. 1) supplies the pixel signal Vpix to each of the signal lines SGL. The drive circuit 18 (refer to FIG. 9) supplies the display drive signal Vcomdc to the detection electrodes 22. These operations cause the display apparatus 1 to perform the display.

During the first sensing period EM, the drive circuit 18 supplies the first drive signal VTP to the gate lines GCL forming the transmitting coil CTx. The first drive signal VTP is the alternating-current rectangular wave that alternately repeats the first voltage VTPH and the second voltage VTPL. An electromotive force due to the magnetic field is generated in the signal lines SGL forming the receiving coil CRx. As a result, the first detection signal Vdet1 is output to the first detection circuit 11. The detection electrodes 22 are not supplied with a voltage signal, and are placed in a floating state.

The first voltage VTPH is a voltage lower than the high-level voltage VGH of the scan signal Vscan. The average value of the first voltage VTPH and the second voltage VTPL equals the low-level voltage VGL. The potential of the gate line GCL is determined by the ratio between the resistance of the gate line GCL and the resistance of the first drive signal supply lines 52, 53 and the second drive signal supply lines 54, 55 coupled to the gate line GCL. The resistance of the gate line GCL is preferably lower than a resistance value of each line of wiring provided in the peripheral area GA so as to keep the potential of the gate line GCL at an off potential of the switching element Tr.

During the second sensing period ES, the drive circuit 18 supplies the second drive signal VSELF to each of the detection electrodes 22. The detection electrode 22 outputs the second detection signal Vdet2 corresponding to the self-capacitance of the detection electrode 22 to the second detection circuit 13. The drive circuit 18 supplies a guard drive signal Vgd to the signal lines SGL. The guard drive signal Vgd is an alternating-current rectangular wave having at least the same amplitude as that of the second drive signal VSELF. For example, the guard drive signal Vgd may be an alternating-current rectangular wave having the same potential and the same phase as those of the second drive signal VSELF. As a result, the display apparatus 1 can restrain the capacitance coupling between the signal lines SGL and the detection electrodes 22.

The timing waveform diagram illustrated in FIG. 15 is merely an example, and can be modified as appropriate. For example, the display period PD, the first sensing period EM, and the second sensing period ES may differ in length from one another. The order of the display period PD, the first sensing period EM, and the second sensing period ES can be modified as appropriate. The processing in only one of the first sensing period EM and the second sensing period ES may be performed during one frame period.

### Fourth Embodiment

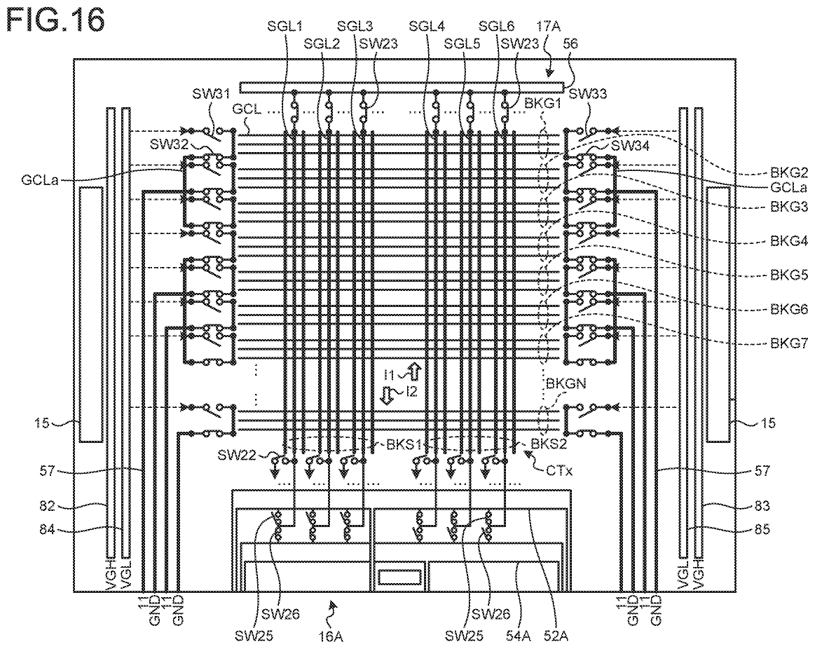

FIG. 16 is a circuit diagram illustrating a coupling configuration of the gate lines and the signal lines according to a fourth embodiment of the present disclosure. In the present embodiment, during the first sensing period, the signal lines SGL are supplied with the first drive signal VTP from the drive circuit 18 to generate a magnetic field, and an electromotive force due to the magnetic field is generated in the gate lines GCL. That is, the signal lines SGL form the transmitting coils CTx, and the gate lines GCL form the receiving coils CRx.

As illustrated in FIG. 16, the coupling configuration of the signal lines SGL is the same as that in FIG. 11 for the second embodiment. The signal line blocks BKS1 and BKS2 and the signal line coupling line 56 form the transmitting coil CTx.

Switches SW31 and SW32 are provided on the left end sides of the gate lines GCL. Switches SW33 and SW34 are provided on the right end sides of the gate lines GCL. During the first sensing period EM, the switches SW32 and SW34 are turned on, and the switches SW31 and SW33 are turned off. As a result, the gate lines GCL are coupled to gate line coupling line GCLa or the detection signal output line 57.

Specifically, the left end of the gate line block BKG1 is coupled to the left end of the gate line block BKG3 through the gate line coupling line GCLa provided in the peripheral area GA. One of the right end of the gate line block BKG1 and the right end of the gate line block BKG3 is coupled to the reference potential (for example, the ground potential GND), and the other thereof is coupled to the first detection circuit 11, through the detection signal output line 57. As a result, the gate line block BKG1, the gate line block BKG3, and the gate line coupling line GCLa form the receiving coil CRx.

In the same manner, the right end of the gate line block BKG2 is coupled to the right end of the gate line block BKGS through the gate line coupling line GCLa provided in the peripheral area GA. One of the left end of the gate line block BKG2 and the left end of the gate line block BKGS is coupled to the reference potential (for example, the ground potential GND), and the other thereof is coupled to the first detection circuit 11, through the detection signal output line 57. As a result, the gate line block BKG2, the gate line block BKGS, and the gate line coupling line GCLa form the receiving coil CRx.

During the display period PD, the switches SW31 and SW33 are turned on, and the switches SW32 and SW34 are turned off. As a result, the gate lines GCL are coupled to the first gate drive signal supply lines 82 and 83 or the second gate drive signal supply lines 84 and 85.

### Fifth Embodiment

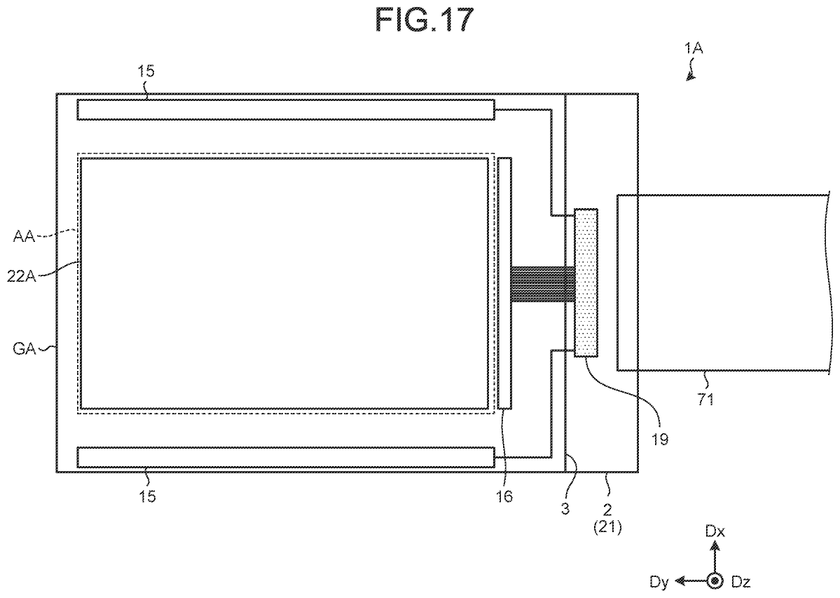

FIG. 17 is a plan view schematically illustrating a display apparatus according to a fifth embodiment of the present disclosure. As illustrated in FIG. 17, a display apparatus 1A of the present embodiment includes a common electrode 22A. The common electrode 22A is provided over the entire area of the display area AA so as to overlap the pixels Pix. That is, the display apparatus 1A does not include the detection electrodes 22, and does not have the self-capacitive touch detection function.

The display apparatus 1A performs the processing during the display period PD and during the first sensing period EM in a time-division manner, without performing the processing during the second sensing period ES. During the display period PD, the drive circuit 18 supplies the display drive signal Vcomdc to the common electrode 22A. During the first sensing period EM, in the same manner as in any of the first to the fourth embodiments, the transmitting coils CTx and the receiving coils CRx are formed by the first electrodes 67 and the signal lines SGL or by the gate lines GCL and the signal lines SGL, and the electromagnetic induction touch detection is performed.

### Sixth Embodiment

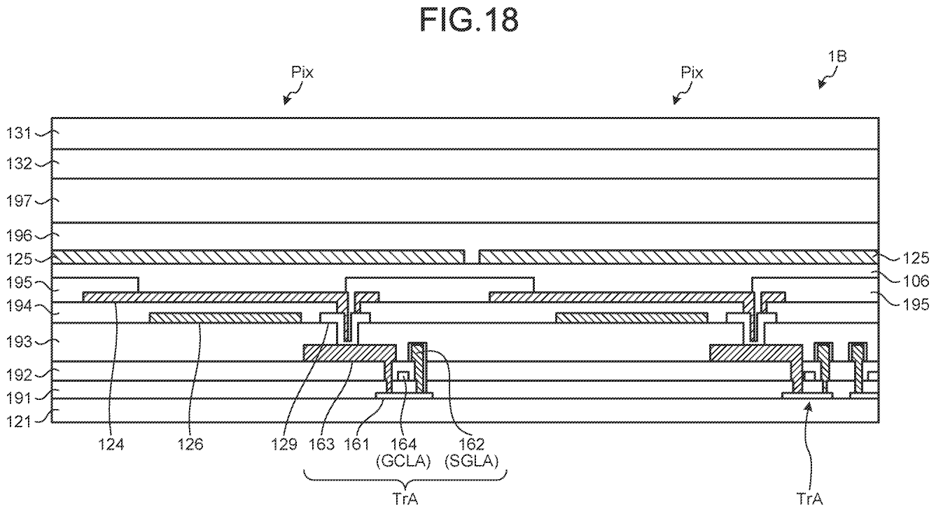

FIG. 18 is a sectional view illustrating a schematic structure of a display apparatus according to a sixth embodiment of the present disclosure. A display apparatus 1B of the present embodiment is a display panel that uses organic light-emitting diodes (OLEDs) as display elements. That is, the display apparatus 1B is not provided with a light source such as a backlight.

As illustrated in FIG. 18, in the display apparatus 1B, a first substrate 121, a switching element TrA, a reflective layer 126, a lower electrode 124, a self-luminous layer 106 serving as the display layer, an upper electrode 125, a barrier layer 196, a filler material 197, and a second substrate 131 are provided so as to be stacked in the order as listed.

The switching element TrA is provided on the first substrate 121. A semiconductor 161 is provided on the first substrate 121. A gate electrode 164 (gate line GCLA) is provided on the upper side of the semiconductor 161 with an insulating layer 191 interposed therebetween. A source electrode 162 (signal line SGLA) and a drain electrode 163 are provided on the upper side of the gate electrode 164 with an insulating layer 192 interposed therebetween. The source electrode 162 and the drain electrode 163 are each electrically coupled to the semiconductor 161 through a contact hole.

An insulating layer 193 is provided on the insulating layer 192 so as to cover the source electrode 162 and the drain electrode 163. The reflective layer 126 is provided on the insulating layer 193, and is formed of a material with a metallic luster that reflects light coming from the self-luminous layer 106. For example, silver, aluminum, or gold is used as the reflective layer 126. The lower electrode 124 is provided on the upper side of the reflective layer 126 with an insulating layer 194 interposed therebetween. The self-luminous layer 106 and the upper electrode 125 are provided so as to be stacked on the upper side of the lower electrode 124 in the order as listed. That is, the self-luminous layer 106 is provided between the lower electrode 124 and the upper electrode 125.

The lower electrode 124 is an anode of the organic light-emitting diode and is provided corresponding to each of the pixels Pix. The upper electrode 125 is a cathode of the organic light-emitting diode. A light-transmitting electrically conductive material such ITO is used as the lower electrode 124 and the upper electrode 125. The self-luminous layer 106 contains a polymeric organic material and includes a hole injection layer, a hole transport layer, a light-emitting layer, an electron transport layer, and an electron injection layer, which are not illustrated.

An insulating layer 195 is an insulating layer that is called a rib and partitions the respective pixels Pix. The barrier layer 196 is provided so as to cover the upper electrode 125 and seals the upper electrode 125. The filler material 197 is a planarizing layer that reduces unevenness produced by the rib. A color filter 132 is provided between the filler material 197 and the second substrate 131.

With the above-described configuration, the light coming from the self-luminous layer 106 passes through the color filter 132, and is emitted from the second substrate 131. Images are displayed on the display surface by controlling the light quantity of the self-luminous layer 106 on a pixel Pix basis. In the display apparatus 1B, the second substrate 131 may be provided on the filler material 197 without providing the color filter 132. In this case, in the self-luminous layer 106, different light-emitting materials are used for the pixels Pix and emit the light in colors of red (R), green (G), and blue (B).

The present embodiment is not limited to the above-described configuration. The lower electrode 124 may be a cathode, and the upper electrode 125 may be an anode. In this case, the polarity of the switching element TrA electrically coupled to the lower electrode 124 can be changed as appropriate.

Also in the present embodiment, the display apparatus 1B can form the transmitting coils CTx and the receiving coils CRx using the gate lines GCLA and the signal lines SGLA for the switching elements TrA. The same configuration as that of the third embodiment or the fourth embodiment described above can be applied to the coupling configuration of the transmitting coils CTx and the receiving coils CRx. Alternatively, in the display apparatus 1B, the first electrode 67 can be provided between the first substrate 121 and the semiconductor 161, and the transmitting coils CTx and the receiving coils CRx can be formed by the first electrodes 67 and the signal lines SGLA. In this case, the same configuration as that of the third embodiment or the fourth embodiment described above can be applied to the coupling configuration of the transmitting coils CTx and the receiving coils CRx.

For example, in the case of the electromagnetic induction touch detection, the drive circuit 18 supplies the first drive signal VTP to the signal lines SGLA. The signal lines SGLA are provided as the transmitting coils CTx, and a magnetic field is generated by the first drive signal VTP. The electromagnetic induction is generated between the signal lines SGLA and the touch pen 100 and between the touch pen 100 and the gate lines GCLA. The electromotive force is generated in the gate lines GCLA by the mutual induction with the touch pen 100. The first detection signal Vdet1 corresponding to this electromotive force is supplied from the gate lines GCLA to the first detection circuit 11.

While the preferred embodiments of the present disclosure have been described above, the present disclosure is not limited to the embodiments described above. The content disclosed in the embodiments is merely an example, and can be variously modified within the scope not departing from the gist of the present disclosure. Any modifications appropriately made within the scope not departing from the gist of the present disclosure naturally belong to the technical scope of the present disclosure. At least one of various omissions, replacements, and modifications of the components can be made without departing from the gist of the above-described embodiments and modifications thereof.

What is claimed is:

1. A display apparatus comprising:
a substrate;
a plurality of pixel electrodes provided in a display area;
a plurality of switching elements coupled to the respective pixel electrodes;
a plurality of first electrodes provided between semiconductors of the switching elements and the substrate in a direction orthogonal to the substrate and extending in a first direction;
a plurality of signal lines coupled to the switching elements and extending in a second direction intersecting the first direction;
a coupling member provided in a peripheral area outside the display area and configured to couple ends of the first electrodes to each other; and
a drive circuit configured to output a first drive signal to the first electrodes or the signal lines during a first sensing period in which an electromagnetic induction method is used.

2. The display apparatus according to claim 1, wherein in the first sensing period,
the first electrodes are supplied with the first drive signal from the drive circuit to generate a magnetic field, and
an electromotive force due to the magnetic field is generated in the signal lines.

3. The display apparatus according to claim 2, further comprising:
a first drive signal supply line configured to supply a first voltage to the first electrodes; and
a second drive signal supply line configured to supply a second voltage lower than the first voltage to the first electrodes, wherein
in the first sensing period:
the first drive signal supply line is coupled to a first end side of at least one of the first electrodes, and the second drive signal supply line is coupled to a second end side thereof, and
the second drive signal supply line is coupled to the first end sides of the first electrodes other than the at least one of the first electrodes, and the first drive signal supply line is coupled to the second end sides thereof.

4. The display apparatus according to claim 2, further comprising:
a first coupling switching circuit configured to couple a first end side of at least one of the signal lines to a first detection circuit in the first sensing period; and
a second coupling switching circuit configured to couple second end sides of the signal lines to each other in the first sensing period.

5. The display apparatus according to claim 1, wherein in the first sensing period,
the signal lines are supplied with the first drive signal from the drive circuit to generate a magnetic field, and
an electromotive force due to the magnetic field is generated in the first electrodes.

6. The display apparatus according to claim 5, further comprising:
a first drive signal supply line configured to supply a first voltage to the signal lines;
a second drive signal supply line configured to supply a second voltage lower than the first voltage to the signal lines;
a first coupling switching circuit configured to couple the first drive signal supply line to a first end side of at least one of the signal lines, and couple the second drive signal supply line to the first end sides of the signal lines other than the at least one of the signal lines in the first sensing period; and
a second coupling switching circuit configured to couple second end sides of the signal lines to each other in the first sensing period.

7. The display apparatus according to claim 5, further comprising:
a detection signal output line that couples a first end side of at least one of the first electrodes to a first detection circuit; and
a first electrode coupling line that couples second end sides of the first electrodes to each other.

8. The display apparatus according to claim 5, wherein
each of the first electrodes is coupled to a detection signal output line through a capacitor, and
the capacitor comprises a first capacitor electrode and a second capacitor electrode opposed to the first capacitor electrode with a dielectric material interposed therebetween.

9. The display apparatus according to claim 1, wherein the first electrodes have light transmittance lower than that of the substrate.
